(19) United States
(12) Patent Application Publication
(10) Pub. No.: US 2004/0006635 A1
(43) Pub. Date: Jan. 8, 2004

(54) Hybrid streaming platform

(76) Inventors: Richard T. Oesterreicher, Naples, FL (US); Craig Murphy, Kirkland, WA (US); George Wright, Duvall, WA (US); Greg Ansley, Alpharetta, GA (US)

Correspondence Address: PENNIE AND EDMONDS, 1155 AVENUE OF THE AMERICAS, NEW YORK, NY, 100362711

(21) Appl. No.: 10/369,305

(22) Filed: Feb. 19, 2003

Related U.S. Application Data
(60) Provisional application No. 60/374,086, filed on Apr. 19, 2002.
(60) Provisional application No. 60/374,090, filed on Apr. 19, 2002.
(60) Provisional application No. 60/373,991, filed on Apr. 19, 2002.
(60) Provisional application No. 60/374,037, filed on Apr. 19, 2002.

(51) Int. Cl. G06F 15/16

(52) U.S. Cl. 709/231

(57) ABSTRACT

A digital-media server platform is disclosed that comprises a hybrid architecture. In a preferred embodiment, the hybrid architecture comprises a dedicated hardware-optimized streaming device that delivers streaming content to a client on a network under control of a general-purpose computer. The architecture also includes an abstraction layer used to interface the general-purpose computer with the streaming device, and several dedicated data buses that connect the general-purpose computer to the streaming device hardware.

### CROSS REFERENCE TO RELATED APPLICATIONS

This application claims benefit of U.S. provisional patent application serial No. 60/374,090, filed Apr. 19, 2002, entitled “Hybrid Streaming Platform,” U.S. provisional patent application serial No. 60/374,086, filed Apr. 19, 2002, entitled “Flexible Streaming Hardware,” U.S. provisional patent application serial No. 60/374,037, filed Apr. 19, 2002, entitled “Optimized Digital Media Delivery Engine,” and U.S. patent application serial No. 60/373,991, filed Apr. 19, 2002, entitled “Optimized Digital Media Delivery Engine,” each of which is hereby incorporated by reference in its entirety for each of its teachings and embodiments.

### FIELD OF THE INVENTION

This invention relates to the field of digital media servers.

### BACKGROUND OF THE INVENTION

General-purpose personal-computer based (PC-based) servers are the standard devices used to serve digital media content. Such PC-based servers are popular because they are relatively inexpensive and readily available. In addition, many existing hardware peripherals and digital media software products are compatible with these servers. For example, software solutions are available for billing integration, targeted-ad insertion, and other tasks associated with streaming services such as video-on-demand (VOD).

Although PC-based architectures are generally adequate for processing a relatively small number of digital-media-delivery transactions, they do not scale well because of the large amount of data copying required to generate wire packets. More specifically, in a PC-based architecture, content to be streamed is first retrieved from storage and copied into RAM by the PC's central processing unit (CPU). The data is then copied again to CPU registers for processing, copied back to RAM, and transmitted via a shared expansion bus to an input/output device. The overhead associated with this repeated copying makes PC-based architectures less efficient as the number of simultaneous digital-media-delivery transactions grows.

PC-based servers also become less reliable as transaction volumes increase. High transaction volumes make such servers unstable and unable to reliably process pending transactions. This results in missing or corrupt data, dropped sessions, and in some cases, complete system failure requiring administrative intervention.

Therefore, PC-based architectures do not represent an optimum design paradigm for reliably delivering digital media in large-scale commercial deployments.

### SUMMARY OF THE INVENTION

A system and method are disclosed for efficiently streaming large transaction volumes while supporting existing digital media streaming software solutions. In a preferred embodiment the disclosed system comprises a hybrid architecture that includes two components. The first component comprises a special-purpose hardware engine designed specifically for streaming digital media content. The second component comprises a general-purpose computer adapted to manage the hardware engine and run any desired streaming software solutions and third-party applications. The result is a streaming platform that features all the scalability and reliability of a dedicated hardware device with the expansion capability and flexibility of a general-purpose computing platform.

The hybrid architecture eliminates most of the data copying bottlenecks presented by a PC-based architecture by shifting streaming tasks to hardware. The hybrid architecture segments and processes digital-media delivery using the task-optimized hardware engine, freeing the general-purpose computer to handle other administrative tasks. By relegating session management and general administrative tasks to the general-purpose computer, the hybrid architecture can manage digital-media delivery without becoming bogged down by the intensive processing necessary to actually construct and deliver digital media streams. Thus, the hybrid platform can manage a much higher number of simultaneous digital media delivery sessions while ensuring a higher level of reliability than can be achieved on a general-purpose computer with an added peripheral card.

In one aspect, the present invention is directed to a system for providing streaming media to a client, comprising:

a digital media storage;

a general-purpose computer adapted to receive requests for digital media from the client via a first network interface; and,

a hardware engine for generating and transmitting wire data packets under control of the general-purpose computer, comprising:

(a) an interface to the digital media storage,

(b) a media buffer adapted to receive digital media assets from the storage interface,

(c) a processor adapted to receive digital media assets from the media buffer and generate wire data packets, and

(d) one or more additional interfaces coupled to the processor and adapted to transmit the wire data packets to the client.

In another aspect of the present invention, the processor is a programmable logic device.

In another aspect of the present invention, the programmable logic device comprises one or more field programmable gate array(s).

In another aspect of the present invention, the system comprises at least one additional hardware engine and the general-purpose computer monitors the transmission of wire data packets by each engine, and transfers the transmission from a failed engine to a functioning engine.

In another aspect, the present invention is directed to a computer readable media having stored thereon programs that cause a general-purpose computer interfaced with one or more hardware engines for generating and transmitting wire data packets to perform functions comprising:

(a) receiving a request for a digital media asset from a client via a network interface; and,

(b) instructing one of the engines to stream the digital media asset to the client in response to the request.

In another aspect of the present invention, the programs comprise commercially available streaming media software.

In another aspect of the present invention, the programs comprise one of: session setup, session management, teardown of streaming sessions, error handling, billing integration and targeted-ad insertion tasks.

In another aspect of the present invention, the media is further adapted to cause the computer to perform additional steps comprising:

(c) monitoring each engine that is streaming; and

(d) transferring the streams from a failed engine to a functioning engine.

In another aspect, the present invention is directed to a method of streaming a digital media asset comprising:

(a) receiving a request for digital media via a first network interface by a general-purpose computer;

(b) said general-purpose computer instructing a streaming hardware engine to send the digital media asset; and,

(c) said streaming hardware engine retrieving the digital media asset from a data store, formatting the data for network transmission, and transmitting the asset via one or more additional interfaces.

### BRIEF DESCRIPTION OF THE DRAWINGS

FIG. 1 is a block diagram illustrating a preferred embodiment of a hybrid architecture for streaming digital media;

FIG. 2 is a block diagram further illustrating components of the hybrid architecture;

FIG. 3 is a flowchart that depicts a preferred embodiment of the operation of the hybrid architecture; and,

FIG. 4 is a block diagram illustrating components of an alternative embodiment of the hybrid architecture with redundant streaming capability.

### DESCRIPTION OF THE PREFERRED EMBODIMENTS

System Architecture

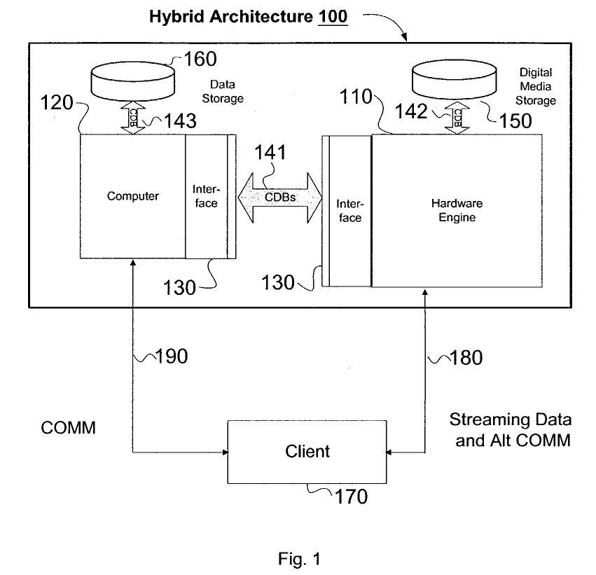

FIG. 1 is a block diagram depicting a preferred embodiment of a hybrid architecture 100 for delivering digital media content. As shown in FIG. 1, hybrid architecture 100 preferably comprises a hardware engine 110 and a general-purpose computer 120.

Hardware engine 110 is preferably coupled to a digital media storage 150 via a common data bus 142. Computer 120 is preferably coupled to a data storage 160 via a common data bus 143. Although shown as distinct storage devices in FIG. 1, those skilled in the art will recognize that digital media storage 150 and data storage 160 may, for example, be implemented in a single storage device having a dual interface configuration that provides concurrent access for hardware engine 110 and computer 120.

Hardware engine 110 is preferably a dedicated high-performance media-delivery engine adapted to receive digital media and generate wire packets under control of computer 120. A preferred embodiment for implementing hardware engine 110 is described in U.S. patent application Ser. No. ______, filed ______, entitled “Flexible Streaming Hardware,” filed on even date herewith (and identified by Pennie & Edmonds attorney docket no. 11055-006-999), which is hereby incorporated by reference in its entirety for each of its teachings and embodiments.

In a preferred embodiment, hybrid architecture 100 further comprises an interface 130. Interface 130 provides a defined set of drivers and/or instructions for communication between computer 120 and hardware engine 110 using common data buses 141. Interface 130 facilitates efficient and direct data transfer to and from hardware engine 110 and requires less data translation and fewer memory and fixed-storage accesses, resulting in a tight integration between hardware engine 110 and computer 120. Interface 130 may preferably comprise software components located in computer 120 and firmware components located in hardware engine 110.

In a preferred embodiment, hybrid architecture 100 further comprises common data buses (CDBs) 141-143. Unlike in the PC-based approach where a single, shared bus provides communications between components, these CDBs provide multiple independent and isolated data pathways designed to increase bandwidth in each data path between components.

Also shown in FIG. 1 is a client device 170 adapted to request and receive digital media. Client device 170 may, for example, be a set-top box, personal computer, or other network appliances designed to request and receive a digital media stream. In a preferred embodiment, client device 170 is coupled to hardware engine 110 via a link 180 and to computer 120 via a link 190. Links 180, 190 may be, for example, digital cable networks or other suitable links for transmitting digital media and other data. A preferred embodiment for communicating data to client device 170 using hardware engine 110 is described in more detail in U.S. patent application Ser. No. ______, filed ______, entitled “Optimized Digital Media Delivery Engine,” filed on even date herewith (and identified by Pennie & Edmonds attorney docket no. 11055-011-999), which is hereby incorporated by reference in its entirety for each of its teachings and embodiments.

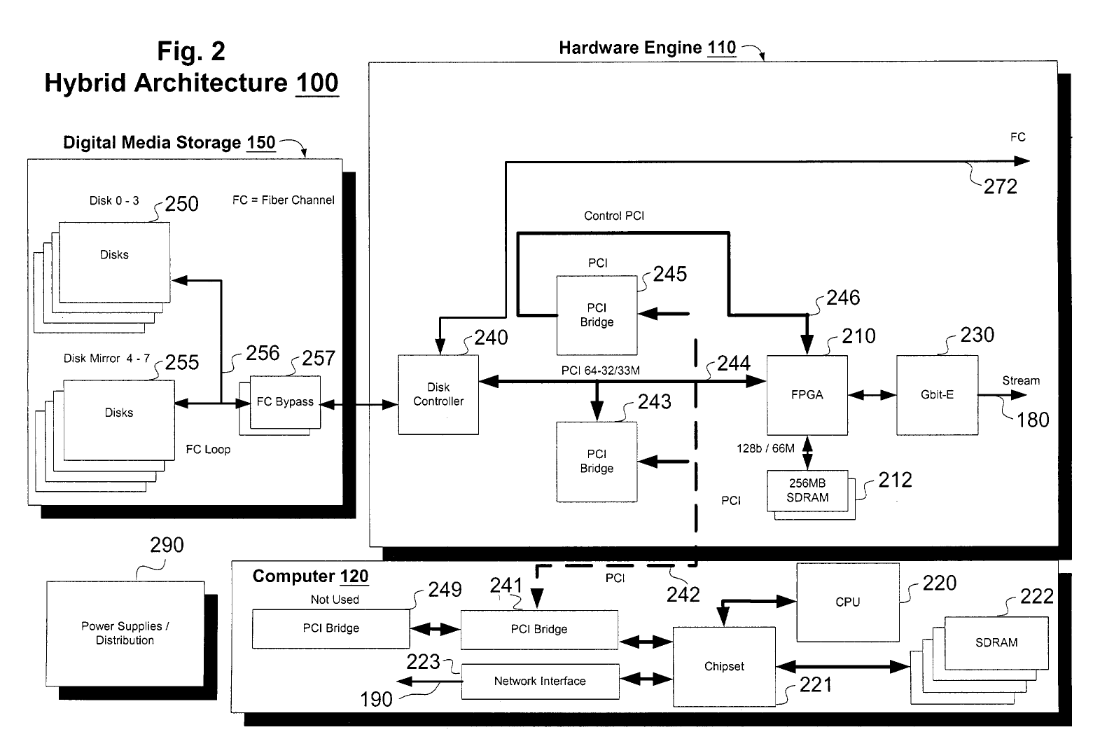

FIG. 2 is a block diagram depicting components of the hybrid architecture in more detail. As shown in FIG. 2, hardware engine 110 preferably comprises one or more programmable logic devices such as field programmable gate arrays (FPGA) 210 and associated media buffers 212 that are adapted to provide hardware-speed generation of wire packets critical to the timely delivery of large-scale digital content. Because programmable logic devices in general, and field programmable gate arrays in particular, can ingest, process, and deliver data at wire-speed, while at the same time remaining programmable, they provide the scalability and reliability of a dedicated hardware device while offering the flexibility of a general-purpose software solution. Additionally, the architecture of hardware engine 110 allows the majority of its functionality to be modified or extended in real-time via its existing external interfaces. With its tremendous data processing power, hardware engine 110 enables features that are simply not possible with general-purpose PCs.

Hardware engine 110 further preferably comprises fiber channel disk controller storage interface 240 for retrieving digital media content to be streamed from digital media storage 150. FPGA 210 preferably accesses interface 240 via a common data bus 244. An external fiber channel connection 272 is preferably provided for access to digital media storage 150 through interface 240.

Hardware engine 110 further preferably comprises a network interface 230 for delivering wire packets generated by FPGA 210 to a client 170 via appropriate high-speed connection 180. In a preferred embodiment, network interface 230 is a gigabit Ethernet interface capable of operating at data rates of at least 1 Gb/sec.

Hardware engine 110 further preferably comprises common data buses 244, 246 that provide data-communication paths between components in hardware engine 110. Preferably, common data buses 244, 246 are 64-bit wide peripheral component interconnect (PCI) buses, running at 66 MHz. Common data bus 244 provides data communication between disk controller storage interface 240 and FPGA 210. Common data bus 246 provides control communications between FPGA 210 and computer 120 through a PCI bridge 245 that links with computer 120's interface bus 242.

In a preferred embodiment, digital media storage 150 comprises multiple internal fiber channel disk drives and an associated fiber channel bypass device 257. These drives are preferably arranged in two groups 250, 255, each group containing half the total quantity of disks. Second group 255 acts as a mirror for first group 250 and contains a copy of the information contained in the disk group. Should a disk fail in first group 250, the information may be obtained from the corresponding disk in second group 255. Preferably, each disk is hot swappable, i.e., the disk can be replaced without powering off hybrid architecture 100.

General-purpose computer 120 provides a standard computing platform and is preferably implemented using commercially-produced CPUs and associated technologies. Within hybrid architecture 100, general-purpose computer 120 performs tasks that are not cost effective to implement in hardware engine 110, not an efficient use of hardware engine 110, or simply better suited to a general-purpose processor. Such tasks may include session setup, management and teardown of streaming sessions, error handling, and running third party software applications, such as targeted-ad insertion or billing integration.

In a preferred embodiment, during normal operation, streaming data processed by hardware engine 110 does not pass through computer 120 at all. This ensures that the load on computer 120 can be maximized without exceeding its practical boundaries and without compromising the quality of digital media delivery.

Computer 120 preferably comprises a CPU 220 and a chipset 221 for interfacing CPU 220 with memory 222 and other peripherals such as PCI bridges 241, 249 and network interface 223. Memory 222 is preferably a 100 MHz synchronous dynamic random access memory. Network interface 223 provides communications with client 170 via link 190. PCI bridge 241 interfaces with PCI bus 242 to permit communication between computer 120 and hardware engine 110. PCI bus 242 is preferably a 64-bit wide data path running at 66 MHz.

Power supplies 290 are preferably dual power supplies adequately provisioned to provide power for the components of hybrid architecture 100. In addition, each power supply is preferably hot swappable in the event of failure.

In a preferred embodiment, computer 120 and hardware engine 110 are reconfigurable. Changes can be made to the software and operating system in computer 120 and to the programmable logic devices of hardware engine 110. This permits hybrid architecture 100 to incorporate innovation independently in computer 120 and hardware engine 110. By using a reconfigurable design for these components, the useful life of the architecture is extended.

System Operation

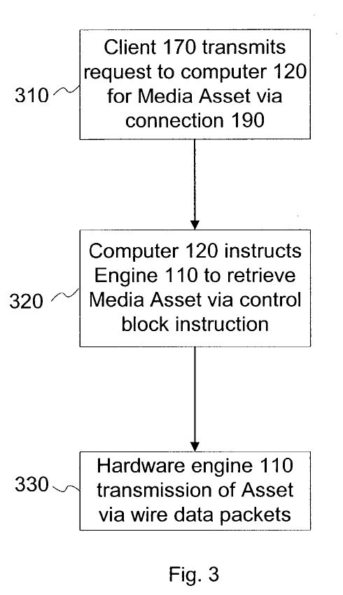

FIG. 3 is a flowchart depicting operation of hybrid architecture 100 in a preferred embodiment. As shown in FIG. 3, in step 310, client 170 transmits a request for digital content to hybrid architecture 100 via link 190 and network interface 122 of computer 120. One or more processes or applications running on computer 120 manage the received request. Application data used by the processes on computer 120 is retrieved from local data store 160 and accessed using CDB 143. Alternatively, for example, when link 190 is unavailable, the client request may be transmitted via communications path 180.

In step 320, computer 120 instructs hardware engine 110 to retrieve the requested media from one or more digital media storage devices 150. Computer 120 provides these instructions via control blocks that are sent to hardware engine 110 through interface 130. Hardware engine 110 generates wire data packets from the stored digital media in accordance with the instructions specified in the control blocks. This aspect of the operation of computer 120 and hardware engine 110 is described in more detail in copending U.S. patent application Ser. No. ______, filed ______, entitled “Flexible Streaming Hardware,” filed on even date herewith (and identified by Pennie & Edmonds attorney docket no. 11055-006-999), which is hereby incorporated by reference in its entirety for each of its teachings and embodiments.

Computer 120 may be provided with commercial off-the-shelf software which can run on computer 120 without porting or translation to a foreign or proprietary architecture. Thus, commercially available streaming software can run as-is on computer 120. Hybrid architecture 100 can therefore leverage a wealth of resources available from third-party application developers, such as targeted-ad insertion or billing integration, while providing the benefit of hardware accelerated digital media delivery.

Interface 130 provides open access to hardware engine 110 by third party applications running on computer 120. Application developers can use application program interfaces conforming to interface 130 requirements without detailed knowledge of hardware engine 110's underlying implementation. This allows hybrid architecture 100 to leverage a wealth of resources available from third-party application developers and enables an additional level of flexibility while providing the benefit of hardware-accelerated digital-media delivery.

In step 330, the requested media is processed within hardware engine 110 and delivered to client 170 through network interface 223. In particular, hardware engine 110 retrieves the media from storage 150, segments the data into packets, and forms wire data packets for transmission through network interfaces 230, 280.

An additional advantage of the present architecture is resistance from network tampering and congestion. With PC-based servers, the CPU and the network interface are shared among all processes involved in the delivery of digital media. If one of these PC-based servers receives a denial of service attack, or if the CPU is overloaded or otherwise affected, digital media streaming maybe disrupted or corrupted and, in many cases, completely halted. This is due to the relatively closed-loop path used for streaming data in the prior art in which the single network interface acts as a communications bottleneck and a point of vulnerability.

By contrast, because digital media processing and session management are compartmentalized within hybrid architecture 100, the present system can continue to process and deliver streaming data to client systems for sessions already in progress, despite a denial of service attack on computer 120 through network interface 223. Because hybrid architecture 110 has separate network interfaces 223, 230 for incoming requests and delivery of streams, it is not as vulnerable to malicious or irregular activity on incoming network interface 223.

Redundant Streaming Capability

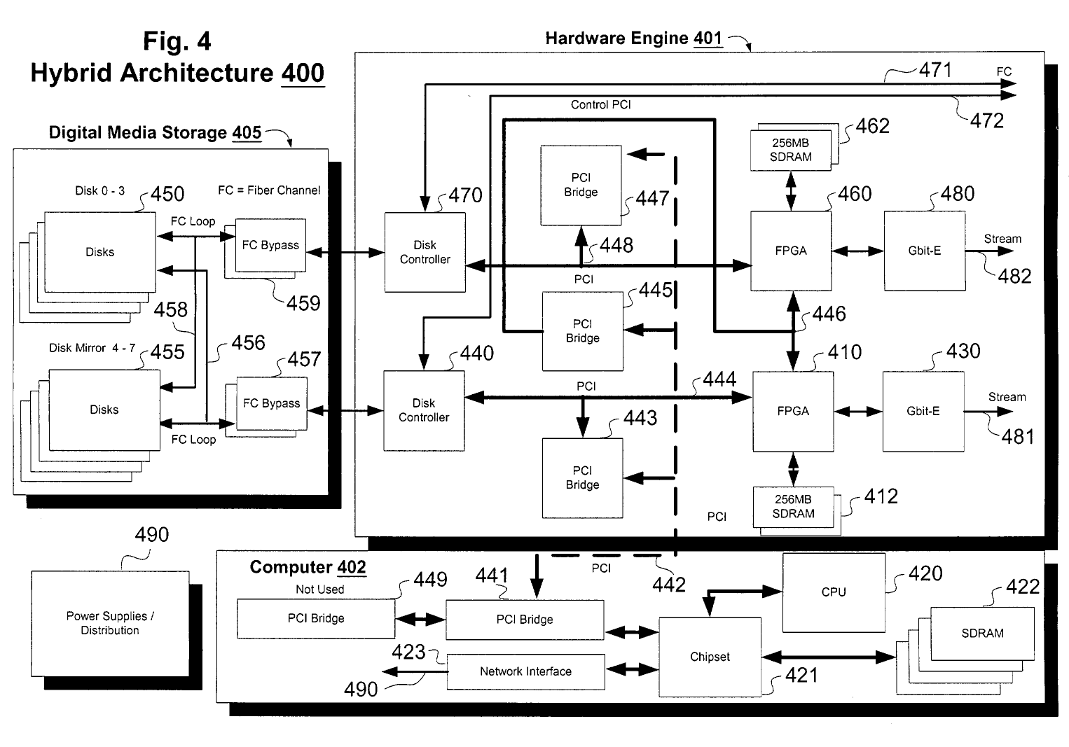

FIG. 4 is a block diagram of another preferred embodiment, in which a hybrid architecture 400 is provided with redundant streaming capability. As shown in FIG. 4, hardware engine 401 preferably comprises two or more programmable logic devices 410, 460 and associated media buffers 412, 462 that are adapted to provide hardware-speed generation of wire packets critical to the timely delivery of large-scale digital content. In a preferred embodiment, programmable logic devices 410, 460 are implemented using FPGAs. Multiple FPGAs increase the bandwidth potential of hybrid architecture 400, effectively multiplying its streaming capacity, and provide redundancy for reliable streaming operation.

Hardware engine 401 further preferably comprises fiber channel disk controller storage interfaces 440 and 470 for retrieving digital media content to be streamed from digital media storage 405. FPGAs 410 and 460 respectively access interfaces 440 and 470 via common data buses 444 and 448. External fiber channel connections 471 and 472 are provided for access to digital media storage through interfaces 440 and 470.

Hardware engine 401 further preferably comprises network interfaces 430 and 480 for delivering wire packets generated by FPGAs 410 and 460 to a client 170 via appropriate high-speed connections 481 and 482. In a preferred embodiment, network interfaces 430 and 480 are gigabit Ethernet interfaces capable of operating at data rates of at least 1 Gb/sec.

Hardware engine 401 further preferably comprises common data buses 444, 446, and 448 which provide data communications paths between components in hardware engine 401. Preferably, common data buses 444, 446 and 448 are 64 bit wide PCI buses, running at 66 MHz. Common data buses 444 and 448 provide the normal data communication path between disk controller storage interfaces 440, 470 and FPGAs 410, 460. Common data bus 446 provides control communications between FPGAs 410, 460 and computer 402 through PCI bridge 445 that links with computer 402's interface bus 442.

Digital media storage 405 preferably comprises multiple internal fiber channel disk drives. These drives are preferably arranged in two groups 450, 455, each group containing half the total quantity of disks. Second group 455 acts as a mirror for first group 450, and contains a copy of the information contained in the disk group. Should a disk fail in first group 450, the information may be obtained from the corresponding disk in second group 455. Preferably, each disk is hot swappable, i.e., the disk can be replaced without powering off hybrid architecture 400.

Digital media storage 405 further preferably comprises dual, redundant fiber channel bypass devices 457 and 459. Disk controller storage interfaces 440, 470 access disks in both groups 450, 455 via bypass devices 457, 459 and fiber channel loops 456, 458.

Computer 402 preferably comprises a CPU 420, a chipset 421 for interfacing CPU 420 with memory 422 and other peripherals such as PCI bridges 441, 449 and network interface 423. Memory 422 is preferably synchronous dynamic random access memory. Network interface 423 provides communications with client 170 via link 490. PCI bridge 441 interfaces with PCI bus 442 to permit communication between computer 402 and hardware engine 401. PCI bus 442 is preferably a 64-bit wide data path running at 66 MHz.

Power supplies 490 are preferably dual power supplies adequately provisioned to provide all necessary power for the components of hybrid architecture 400. In addition, each power supply is preferably hot swappable in the event of failure.

Additionally, hardware engine 401 is preferably adapted to switch the delivery of the stream over between FPGAs 410, 460 in the event of a failure. As in the preferred embodiment described above, hardware engine 401 is preferably monitored by computer 402 and delivers digital media under control of instruction blocks from computer 402. In the event of a failure of an FPGA, computer 402 instructs hardware engine 401 to transfer streaming tasks from the failing FPGA to the operating FPGA.

While the invention has been described in conjunction with specific embodiments, it is evident that numerous alternatives, modifications, and variations will be apparent to those skilled in the art in light of the foregoing description.

What is claimed is:

1. A system for providing streaming digital media to a client, comprising:
a digital media storage;
a general-purpose computer adapted to receive requests for digital media from the client via a first network interface; and,
a hardware engine for generating and transmitting wire data packets under control of the general-purpose computer, comprising:
(a) an interface to the digital media storage,
(b) a media buffer adapted to receive digital media assets from the storage interface,
(c) a processor adapted to receive digital media assets from the media buffer and generate wire data packets, and
(d) one or more additional interfaces coupled to the processor and adapted to transmit the wire data packets to the client.

2. The system of claim 1, wherein the processor is a programmable logic device.

3. The system of claim 2, wherein the programmable logic device comprises one or more field programmable gate arrays.

4. The system of claim 1, comprising at least one additional hardware engine and wherein the general-purpose computer monitors the transmission of wire data packets by each engine, and transfers the transmission from a failed engine to a functioning engine.

5. A computer readable media having stored thereon programs that cause a general-purpose computer interfaced with one or more hardware engines for generating and transmitting wire data packets to perform functions comprising:
(a) receiving a request for a digital media asset from a client via a network interface; and,
(b) instructing one of the engines to stream the digital media asset to the client in response to the request.

6. The media of claim 5, wherein the programs comprise commercially available streaming software.

7. The media of claim 6, wherein the programs comprise one of: session setup, session management, teardown of streaming sessions, error handling, billing integration and targeted-ad insertion tasks.

8. The media of claim 5, further adapted to cause the computer to perform additional steps comprising:
(c) monitoring each engine that is streaming; and
(d) transferring the streams from a failed engine to a functioning engine.

9. A method of streaming a digital media asset comprising:
(a) receiving a request for digital media via a first network interface by a general-purpose computer;
(b) said general-purpose computer instructing a streaming hardware engine to send the digital media asset; and,
(c) said streaming hardware engine retrieving the digital media asset from a data store, formatting the data for network transmission, and transmitting the asset via a second network interface.
